(19) United States
(12) Patent Application Publication
(10) Pub. No.: US 2026/0002918 A1
(43) Pub. Date: Jan. 1, 2026

(54) ANTI-FREEZE SOLUTIONS FOR VISUAL INDICATORS OF BIOSPECIMEN TIME-TEMPERATURE EXPOSURE

(71) Applicant: ARIZONA BOARD OF REGENTS ON BEHALF OF ARIZONA STATE UNIVERSITY, Scottsdale, AZ (US)

(72) Inventor: Chad BORGES, Avondale, AZ (US)

(21) Appl. No.: 18/993,254

(22) PCT Filed: Jul. 13, 2023
(86) PCT No.: PCT/US2023/070129

§ 371 Date: Jan. 10, 2025

Related U.S. Application Data
(60) Provisional application No. 63/388,885, filed on Jul. 13, 2022.

(51) Int. Cl. G01N 31/22; G01N 21/78

(52) U.S. Cl. CPC G01N 31/229; G01N 21/78

(57) ABSTRACT

An indicator system comprising permanganate, an organic reducing agent, an acid, and an inorganic perchlorate salt is provided herein. Methods for using the indicator system to monitor the integrity of a biospecimen are also provided. The systems and methods herein may provide easy-to-use, individual aliquot-level thawed-state indicators for indicating biospecimen time-temperature exposure.

### CROSS-REFERENCE TO RELATED APPLICATIONS

The present application claims priority to U.S. Provisional Patent Application No. 63/388,885, filed Jul. 13, 2022, the content of which is hereby incorporated by reference in its entirety.

### STATEMENT REGARDING FEDERALLY SPONSORED RESEARCH

This invention was made with government support under R21 CA250999 awarded by the National Institutes of Health. The government has certain rights in the invention.

### BACKGROUND OF THE INVENTION

Many biological analytes of interest to clinical researchers are unstable when the biospecimens in which they reside are thawed, improperly stored, or improperly handled. For example, American Society of Clinical Oncology (ASCO)/College of American Pathologists (CAP) guidelines state that cold ischemic time prior to fixation for tissues collected for clinical HER2 testing in breast cancer must be less than 1 hour. Estrogen receptor (ER) tests are more likely to yield false negative results when tissues are subjected to sustained periods of cold ischemia, as commonly occurs after surgical resection vs. biopsy. For blood plasma/serum and many types of tissue specimens that are to be frozen, the proper cold storage temperature is well below the common laboratory freezer temperature of −20° C. Free prostate specific antigen (PSA) in serum loses stability in <4 hrs at 4° C. Cell free DNA is unstable in plasma stored at 4° C. for 24 hrs. And TIMP-1, VEGF and VEGF-R in serum lose stability after about 3 months of storage at −20° C. but are stable at −75° C. Every year, improprieties and inconsistencies in pre-analytical sample handling and storage (which includes inconsistencies in biobanking practices) generate unacceptably large numbers of costly false leads in biomedical research and compromise diagnostic integrity. Currently there are few tools and no widely accepted approach by which to implement evidence-based tracking of biospecimen exposure to thawed conditions.

Ex vivo biospecimen handling and storage conditions have the potential to impact measurements of certain clinical biomarkers as much or more than in vivo (clinical) conditions of interest. As such, utilization of compromised biospecimens in diagnosis or biomedical research can lead directly to false conclusions. The danger of false discovery/false conclusions is particularly strong for untargeted biomarker discovery studies or in cases of targeted analysis where the stability of the target analyte(s) have not yet been validated. There are numerous pre-analytical variables (PAVs) that can compromise the integrity of tissues and biofluids collected for biomedical research. For frozen specimens, the most difficult PAV to control and track over the lifetime of the archived samples is exposure to thawed conditions-particularly at the individual aliquot level. Analytes of clinical interest within all types of frozen biospecimens exhibit quantitative instability when the biospecimen is exposed to thawed conditions. Although this problem is sometimes ignored or given low priority, more biomedical researchers are becoming aware of the potential disasters that can be caused by employing biospecimens in their research that have undocumented or questionable history.

Common ways of dealing with this problem are to follow a standard operating procedure (SOP) and document deviations, or implement evidence-based tracking of biospecimen exposure to thawed conditions. Unfortunately, there are very few tools and no widely accepted approach for evidenced-based biospecimen quality assurance (QA) or quality control (QC) which, in addition to careful SOP adherence and documentation, is undoubtedly the most ideal. In practice, it is actually quite rare for biomedical researchers to employ any evidence-based QA/QC tools at all. Thus, there is a need for easy-to-use, individual aliquot-level thawed-state indicators for indicating biospecimen time-temperature exposure.

### SUMMARY OF THE INVENTION

In a first aspect, provided herein is an indicator system comprising permanganate, an organic reducing agent (such as oxalate), an acid, an aqueous solvent, and an inorganic perchlorate salt initially configured to prevent reduction of the permanganate to Mn²⁺. A mixture of the permanganate, the organic reducing agent, the acid, the aqueous solvent, and the inorganic perchlorate salt is an eutectic composition having a predetermined freezing point. At temperature above the predetermined freezing point, the organic reducing agent causes a reduction reaction of perchlorate to Mn²⁺, and at temperature below the predetermined freezing point the reduction reaction is stopped.

In some embodiments, the inorganic perchlorate salt is selected from the group consisting of sodium perchlorate (NaClO₄), magnesium perchlorate (Mg(ClO₄)₂), and lithium perchlorate (LiClO₄). In some embodiments, the eutectic composition comprises between about 15% and about 60% by weight of the inorganic perchlorate salt.

In some embodiments, the predetermined freezing point is below −10.0° C., including for example −18° C., −37° C., and −67° C.

In some embodiments, the predetermined freezing point is in a range of −16° C. to −20° C. (e.g., −18° C.) and the eutectic composition comprises between 20% and 30% (e.g., about 25%) by weight LiClO₄. In some embodiments, the predetermined freezing point is in a range of −35° C. to −39° C. (e.g., −37° C.) and the eutectic composition comprises between 50% and 54% (e.g., about 52%) by weight NaClO₄. In some embodiments, the predetermined freezing point is in a range of −65° C. to −69° C. (e.g., −67° C.) and the eutectic composition comprises between 42% and 46% (e.g., about 44%) by weight Mg(ClO₄)₂.

In some embodiments, the eutectic composition comprises sodium perchlorate, magnesium perchlorate, or lithium perchlorate in the same relative amounts used in the preceding paragraph. For example, in some cases, the eutectic composition comprises 8.9 molal sodium perchlorate (mol sodium perchlorate per kg solvent). In some cases, the eutectic composition comprises 3.7 molal magnesium perchlorate. In some cases, the eutectic composition comprises 3.1 molal lithium perchlorate. In some embodiments, the eutectic composition comprises between 0.5 mM and 5 mM permanganate. In some embodiments, the eutectic composition comprises between 1 and 15 mM organic reducing agent. In some embodiments, the eutectic composition comprises between 1 mM and 300 mM sulfuric acid or perchloric acid.

In some embodiments, the indicator system further comprises a multi-chambered storage vessel comprising a removable barrier defining a first chamber having the permanganate therein and a second chamber having the organic reducing agent therein where the removable barrier is configured to prevent the permanganate and the organic reducing agent from mixing. In some embodiments, the first chamber has a permanganate salt therein and the second chamber has a solution comprising the organic reducing agent, the acid, the aqueous solvent, and the inorganic perchlorate salt therein.

In some embodiments, the indicator system additionally comprises a storage vessel and the eutectic composition is built into a portion of the storage vessel. In some embodiments, the storage vessel is a multi-chambered storage vessel.

In a second aspect, provided herein is a biospecimen collection or storage system comprising a storage vessel (configured to hold a biospecimen) and any of the indicator systems described herein. In some embodiments, the biospecimen collection or storage vessel comprises a recess configured to receive the indicator system and allows observation of the indicator system without disturbing the biospecimen.

In a third aspect, provided herein is a method for monitoring storage of a biospecimen comprising: storing a biospecimen in a biospecimen storage vessel (e.g., configured to hold the biospecimen therein); associating any of the indicator systems described herein with the biospecimen or the biospecimen storage vessel (e.g., having a chamber configured to contain the biospecimen); mixing the permanganate, the organic reducing agent, the acid, the aqueous solvent, and the inorganic perchlorate salt, thereby forming the eutectic composition; and observing the color of the eutectic composition or measuring absorbance at 525 nm; wherein a color change from pink to colorless or absorbance less than 0.1 indicates thawing, improper storage, or improper handling of the biospecimen.

Advantageously, the present systems provide instant visual assessment of biospecimen integrity at the individual aliquot level. Such systems are also designed to track limited exposure (of minutes to hours) of the biospecimen at contraindicated temperatures. Further yet, the indicators described herein can be customized to specific storage conditions and time-temperature exposure intervals.

### BRIEF DESCRIPTION OF DRAWINGS

FIGS. 1A-1B illustrate an exemplary biospecimen collection or storage system having an indicator system (FIG. 1A) and a vessel for holding a biospecimen (FIG. 1).

FIG. 2A shows permanganate reduction time courses (n=6) at 25° C. for a 52% (w/w) NaClO₄ system monitored by absorbance at 525 nm. The final concentrations of potassium permanganate, disodium oxalate, and perchloric acid were 0.5 mM, 1.38 mM, and 10 mM, respectively. FIG. 2B shows results of an illustrative 52% (w/w) NaClO₄ system that freezes eutectically at −37° C. and was designed to run for 60 minutes at 25° C. (n=3 replicates overlaid).

FIG. 3 shows run time vs. temperature profiles for a 52% (w/w) NaClO₄ systems that freeze eutectically at −37° C. The two digits at the end of each legend entry (“N-37C-xx”) indicate the time, in minutes, at which the reaction system was designed to run at 25° C.

FIG. 4 shows impact of multiple preliminary freeze-thaw cycles on final reaction run time for 25% (w/w) NaClO₄ system that freezes eutectically at −37° C. and nominally runs for 30 minutes at 25° C. in the absence of any freeze-thaw cycles. The results of 1 to 6 freeze-thaw cycles (n=3) are shown.

FIG. 5A shows permanganate reduction time courses (n=6) at 25° C. for a 44% (w/w) Mg(ClO₄)₂ system monitored by absorbance at 525 nm. The final concentrations of potassium permanganate, disodium oxalate, and perchloric acid were 0.5 mM, 1.38 mM, and 10 mM, respectively. FIG. 5B results of an illustrative 44% (w/w) Mg(ClO₄)₂ system that freezes eutectically at −67° C. and was designed to run for 30 minutes at 25° C. without transitioning through a brown-colored intermediate (n=3 replicates overlaid).

FIG. 6 shows run time vs. temperature profiles for 44% (w/w) Mg(ClO₄)₂ systems that freeze eutectically at −67° C. without going through a brown-colored intermediate. The two digits at the end of each legend entry (“N-67C-xx”) indicate the time, in minutes, at which the reaction system was designed to run at 25° C.

FIG. 7 shows results of an illustrative 25% (w/w) LiClO₄ system that freezes eutectically at −18° C. and was designed to run for 60 minutes at 25° C. (n=3 replicates overlaid).

FIG. 8 shows run time vs. temperature profiles for 25% (w/w) LiClO₄ systems that freeze eutectically at −18° C. The two digits at the end of each legend entry (“N-18C-xx”) indicate the time, in minutes, at which the reaction system was designed to run at 25° C.

FIG. 9 shows impact of multiple preliminary freeze-thaw cycles on final reaction run time for 25% (w/w) LiClO₄ system that freezes eutectically at −18° C. and nominally runs for 30 minutes at 25° C. in the absence of any freeze-thaw cycles.

### INCORPORATION BY REFERENCE

All publications, patents, and patent applications mentioned in this specification are herein incorporated by reference to the same extent as if each individual publication, patent, and patent application was specifically and individually indicated to be incorporated by reference.

### DETAILED DESCRIPTION OF THE INVENTION

The present disclosure describes colorimetric indicators for monitoring the handling and storage of biospecimens. The change in color of the indicator indicates that a biospecimen has thawed, been improperly stored, or improperly handled. The indicator systems described herein serve as a “clock” that slows when samples are cooled and stops when frozen but restarts when thawed. The indicator is not limited to a particular number of freeze/thaw cycles, but rather is a measure of time above a predetermined freezing point threshold temperature.

The presently disclosed indicators provide objective evidence that a biospecimen has been thawed, improperly stored, or improperly handled. Evidence-based biospecimen QA/QC tracking can be broken down into two major forms: endogenous markers and exogenous indicators. Endogenous markers have the advantage that they need not be added to samples at collection, making it possible to use them retrospectively for analysis of existing samples. However, endogenous markers suffer from several inherent disadvantages: they may only be useful for specific biospecimen, testing requires consuming some of the sample, possess natural sample-to-sample variability, require instrumental analysis, and their use may be limited to specific time or temperature regimes. As such, there exists a need for exogenous integrity markers that overcome these disadvantages common to endogenous integrity markers.

In one aspect, the present disclosure provides an indicator system comprising permanganate, an organic reducing agent, an acid, an aqueous solvent, and an inorganic perchlorate salt initially configured to prevent reduction of the permanganate to Mn²⁺, wherein a mixture of the permanganate, the organic reducing agent, the acid, the aqueous solvent, and the inorganic perchlorate salt is an eutectic composition having a predetermined freezing point, and wherein at temperature above the predetermined freezing point the organic reducing agent causes a reduction reaction of permanganate to Mn²⁺ and at temperature below the predetermined freezing point the reduction reaction is stopped.

The presently disclosed exogenous indicators possess a number of advantages: (1) the indicators work with any type of tissue or fluid biospecimen (liquid or solid regardless of anatomical source); (2) the indicators eliminate sample consumption or disturbance of the biospecimen as part of the integrity check process; (3) the indicators force itself upon sample handlers with its bright pink indicator, allowing for ultra-rapid visual inspection and making it impossible to ignore improperly handled sample; (4) the indicators may be based on inexpensive chemicals, limiting implementation costs; (5) the indicators indicate biospecimen exposure beyond a tightly pre-defined time interval above a given temperature; and (6) the indicators eliminate reliance on written handling/storage records, which may be a common source of false confidence when it comes to the integrity of archived biospecimens.

As used herein, “biospecimen” refers to a sample of material from a human, plant, animal, bacteria, fungi, or other living organism. A biospecimen may be a biofluid (e.g., blood, urine, semen, tears, plasma, sweat, bile, breast milk, cerebrospinal fluid, etc.), a tissue sample (e.g., a biopsy sample, muscle tissue, bone, bone marrow, etc.), cells (e.g., bacterial cells, fungal cell, stem cells, blood cells, bone marrow cells, etc.), or biochemical material (e.g., DNA, RNA, proteins, lysates, etc.).

As used herein, an indication that a biospecimen has been “thawed, improperly stored, or improperly handled” generally means that the biospecimen has been exposed to an undesirably high temperature or an undesirable amount of time that is outside of suitable safe storage and handling parameters for the associated biospecimen. Suitably, safe storage and handling parameters facilitate the stability of the molecular components thereof. When the biospecimen has been thawed, improperly stored, or improperly handled, the biospecimen may have compromised integrity. As used herein, “compromised integrity” means that the biospecimen may become unsuitable for a diagnostic or analytic use (e.g., by either losing or developing a particular quality or characteristic). The biospecimen may be unsuitable for a diagnostic or analytic use because its molecular composition no longer reflects its original state.

The biospecimen is stored adjacent to or in the proximity of the indicator system described herein and the indicator system is tuned such that when the color of the indicator system changes from bright pink to colorless, the biospecimen has been thawed, improperly stored, or improperly handled in a manner that may compromise the integrity of the biospecimen. As used herein, “biospecimen adjacent to,” “biospecimen associated with,” and “biospecimen in the vicinity of” the indicator system described herein, are used interchangeably and refer to the intimate proximity and simultaneous handling of the biospecimen and the indicator system such that the biospecimen and the indicator system constantly and continuously experience the same storage conditions, same temperature changes, and same environmental conditions. When the biospecimen is adjacent to, associated with, or in the vicinity of the indicator system, they may be in separate containers or vessels that are reversibly or irreversibly bound together. In some embodiments, the biospecimen may be associated with the indicator with tape, glue, a rubber band, parafilm, saran wrap, cling film, aluminum foil or tin foil, wrapped in paper, etc. The biospecimen and the indicator system may be in separate containers or vessels that are stored in the same box, container, freezer, or other appropriate storage system.

In some embodiments, the biospecimen is a biopsy sample. The biopsy sample may be immediately associated with the indicator system following excision from the subject such that the integrity of the biopsy sample can be continually monitored from excision up to fixation. Immediate association of the biopsy sample with the indicator system described herein ensures that the biopsy sample is not improperly handled after excision and before fixation to prevent inaccurate results of subsequent testing due to improper handling and storage of the biopsy sample. The biopsy sample may be any sample taken of a subject for suitable purposes known in the art. In some embodiments, the biopsy sample is a tissue sample for cancer diagnosis.

In some embodiments, the biospecimen is part of a biobank or an archive where long-term storage and handling of said biospecimen is to be monitored. In a biobank or archive, the indicator system described herein may be adjacent to or associated with a single biospecimen or group of biospecimens that are consistently handled simultaneously. Use of the indicator system described herein to monitor biobank or archive biospecimen samples ensures the integrity of the biospecimen over longer periods of time and across multiple laboratories or standard operating procedures (SOPs) responsible for maintaining the biobank or archive.

The indicator system comprises chemical components, that when mixed, provide a solution having an initial bright pink color that fades due to the reduction of permanganate to Mn²⁺. The chemical components of the indicator system may be selected such that when the liquid is colorless or below a threshold absorbance value, the indicator and any biospecimen associated therewith, may have been thawed, improperly stored, or improperly handled. The indicators are designed to function at a number of different temperature or storage regimes that are relevant to critical storage or handling parameters for a variety of biospecimens.

The indicator system described herein utilizes permanganate reaction chemistry with reaction kinetics controlled to be in parallel with the lifespan of a particular biospecimen of interest under thawed, improperly storage, or improperly handled conditions. Permanganate (MnO₄⁻), which gives the indicator an initial bright pink color, is reacted with an organic reducing agent, such as oxalate (C₂O₄²⁻) or its conjugate acid (H₂C₂O₄), under acidic conditions to yield colorless manganese (Mn²⁺), water, and carbon dioxide (an example of such reduction reaction is shown in Scheme 1). When the reaction composition is liquid, the reaction is autocatalytic and an initial bright pink color fades over time and becomes colorless. When the reaction is cooled, the reaction rate slows and when frozen solid, the reaction is essentially stopped.

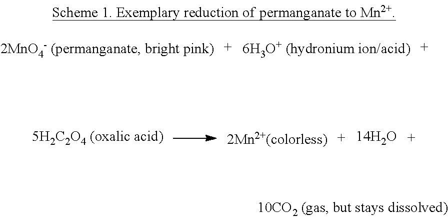

The actual reaction mechanism is complex and takes place in numerous different steps that interplay with one another, but the rate law and/or equilibrium constant at room temperature (25° C.) for each step may be ascertained by known physical and analytical methods. As an example, a computer-based mathematical simulation of the reaction was created using a software (e.g., MatLab). By running this simulation under different reaction starting conditions, it was discovered that proper adjustment of initial solution composition could permit the formulation of solutions that expired in time frames of as little as a few seconds or up to hours at room temperature, or longer at temperatures between 0 and 25° C.

The fact that the reaction takes longer at colder temperatures is well aligned with the fact that biological specimens maintain their stability better at colder temperatures. Thus, if an indicator is physically linked to a biospecimen (for example, by virtue of them being kept within different sub-compartments of the same storage vessel), then placement of the biospecimen under lower temperature (e.g., on ice) as a preservative measure between the point of collection and final archival storage will slow the expiration of both the biospecimen and the indicator simultaneously. Similarly, accidental exposure to higher temperatures will accelerate the expiration of both the specimen and the indicator.

In the presently-disclosed systems, oxalate is an exemplary organic reducing agent, though other organic reducing agents may be utilized. Permanganate is able to oxidize carbon atoms if they contain sufficiently weak (or reactive) bonds, including (1) Carbon atoms with R bonds, such as alkenes and alkynes; (2) carbon atoms with weak C—H bonds, such as C—H bonds in the alpha-positions of substituted aromatic rings and C—H bonds in carbon atoms containing C-0 bonds, including alcohols and aldehydes; and (3) carbons with exceptionally weak C—C bonds, such as C—C bonds in a glycol and C—C bonds next to an aromatic ring and an oxygen.

The composition and concentration of the chemical components allows for control of the freezing point of the indicator system and manipulation of the reaction rate such that the reaction rate and freezing point are in parallel with the lifespan of a thawed, improperly stored, or improperly handed biospecimen. When the reaction compositions changes from bright pink to colorless, the indicator indicates that the biospecimen may have compromised integrity and may no longer be considered suitable for its intended use.

The chemical components of the indicator system are selected such that a mixture thereof forms a eutectic composition including permanganate, organic reducing agent, an acid, a solvent (such as water), and an inorganic perchlorate salt. The addition of an inorganic perchlorate salt to the eutectic composition should be done at a concentration that maintains the eutectic properties of the composition and does not significantly alter the initial bright pink color of the composition.

As used herein, “eutectic composition” refers to a homogeneous composition that freezes and thaws at essentially a single temperature and does not partially freeze, partially thaw, or precipitate out of the composition. As used herein, “eutectic concentration” is the concentration of a composition or compound at which the composition or compound freezes and thaws at essentially a single temperature without partially freezing or partially thawing or the concentration of a compound in solution at which the solution freezes and thaws at essentially a single temperature without partially freezing or partially thawing.

As used herein, “essentially a single temperature” means that all of the chemical components of the eutectic composition freeze or thaw within 2.0° C. Accordingly, small deviations in the concentration of the components from a perfect eutectic concentration are contemplated. In some embodiments, all of the components of the eutectic composition freeze or thaw within 1.0° C., 0.5° C., or 0.2° C. of each other. When the difference in freezing or thawing temperatures of the components is too large, kinetic control of the permanganate/oxalic acid reaction system may be lost.

The permanganate (MnO₄) in the eutectic composition may be provided as any suitable permanganate salt known in the art. The permanganate is provided in the eutectic composition at a concentration suitable to produce an initial bright pink color detectable to the naked eye. The permanganate may be present at a concentration between about 0.1 mM and about 10 mM, including but not limited to between about 0.1 mM and about 8 mM, between about 0.1 mM and about 5 mM, between about 0.2 mM and about 10 mM, between about 0.2 mM and about 8 mM, between about 0.2 mM and about 5 mM, between about 0.5 mM and about 10 mM, between about 0.5 mM and about 8 mM, and between about 0.5 mM and about 5 mM. In some embodiments, the eutectic composition comprises between about 0.5 mM and about 5 mM permanganate. For example, the permanganate may be present at a concentration of about 0.1 mM, 0.25 mM, 0.5 mM, 0.75 mM, 1 mM, 1.5 mM, 2 mM, 2.5 mM, 3 mM, 4 mM, 5 mM, 6 mM, 7 mM, 8 mM, 9 mM, or 10 mM. Suitable permanganate salts include, but are not limited to, ammonium permanganate (NH₄MnO₄), potassium permanganate (KMnO₄), sodium permanganate (NaMnO₄), magnesium permanganate (Mg(MnO₄)₂), and any suitable hydrate thereof. In some embodiments, the permanganate is potassium permanganate. In some embodiments, the permanganate is potassium permanganate at a concentration between about 0.1 mM and about 2 mM, including for example, 0.25 mM, 0.5 mM, 0.75 mM, and 1 mM. In some embodiments, the permanganate is sodium permanganate at a concentration between about 0.1 mM and about 2 mM, including for example, 0.25 mM, 0.5 mM, 0.75 mM, and 1 mM.

The presence of permanganate in the eutectic compositions gives an initial bright pink color. In general, the bright pink color is visible to the naked eye, and the naked eye can detect and observe the transition from bright pink to colorless during the reduction of permanganate. As used herein, “bright pink” and “pink” are used interchangeably and refer to the color associated with an absorbance at 525 nm. When measured using a spectrophotometer, the initial eutectic composition generally has an initial absorbance between about 0.5 and 1.5, but eutectic compositions having an initial absorbance outside of this range may also be utilized. Upon reduction of the permanganate in the eutectic composition, the color of the composition changes from pink to colorless as observed by the naked eye. When measured using a spectrophotometer, the colorless composition may have an absorbance at 525 nm of less than 0.1 (e.g., 0.1, 0.05, or 0). In some embodiments, thawing, improper storage, or improper handling of a biospecimen is indicated by a change in color from pink to colorless as observed by the naked eye and proper storage is indicated by a sustained pink color as observed by the naked eye. In some embodiments, thawing, improper storage, or improper handling of a biospecimen is indicated by at least a 50% reduction in absorbance at 525 nm when measured using a spectrophotometer and proper storage is indicated by a less than 50% reduction in absorbance at 525 nm when measured using a spectrophotometer. In some embodiments, thawing, improper storage, or improper handling of a biospecimen is indicated by at least a 80%, 90%, 95%, or 99% reduction in absorbance at 525 nm when measured using a spectrophotometer.

The organic reducing agent may be provided in any suitable form that allows for reduction of permanganate. The organic reducing agent may be present at a concentration between about 0.1 mM and about 100 mM, including but not limited to between about 0.1 mM and about 50 mM, between about 0.1 mM and about 25 mM, between about 0.5 mM and about 100 mM, between about 0.5 mM and about 50 mM, between about 0.5 mM and about 25 mM, between about 1 mM and about 100 mM, between about 1 mM and about 50 mM, between about 1 mM and about 25 mM, between about 1 mM and about 20 mM, and between about 1 mM and about 15 mM. For example, the organic reducing agent may be present at a concentration of about 0.1 mM, 0.25 mM, 0.5 mM, 0.75 mM, 1 mM, 1.5 mM, 2 mM, 2.5 mM, 3 mM, 4 mM, 5 mM, 6 mM, 7 mM, 8 mM, 9 mM, 10 mM, 15 mM, 20 mM, 25 mM, 30 mM, 35 mM, 40 mM, 45 mM, 50 mM, 55 mM, 60 mM, 65 mM, 70 mM, 75 mM, 80 mM, 85 mM, 90 mM, 95 mM, or 100 mM. In some embodiments, the organic reducing agent is at a concentration between about 0.5 mM and about 20 mM. In certain other embodiments, the organic reducing agent is at a concentration between about 1 mM and about 15 mM, including for example, 0.75 mM, 1 mM, 1.5 mM, 2 mM, and 2.5 mM.

Oxalate in the eutectic composition may be provided as oxalic acid or any suitable oxalate salt known in the art. The oxalate is provided in the eutectic composition at a concentration suitable to autocatalyze the reduction of permanganate to manganese. The oxalate concentration in the reaction is dependent on the permanganate concentration. The oxalate may be present at a concentration between about 0.1 mM and about 100 mM (e.g., 0.1 mM, 0.25 mM, 0.5 mM, 0.75 mM, 1 mM, 1.5 mM, 2 mM, 2.5 mM, 3 mM, 4 mM, 5 mM, 6 mM, 7 mM, 8 mM, 9 mM, 10 mM, 15 mM, 20 mM, 25 mM, 30 mM, 35 mM, 40 mM, 45 mM, 50 mM, 55 mM, 60 mM, 65 mM, 70 mM, 75 mM, 80 mM, 85 mM, 90 mM, 95 mM, 100 mM). Suitable oxalate compounds include, but are not limited to, oxalic acid (H₂C₂O₄), sodium oxalate (Na₂C₂O₄), potassium oxalate (K₂C₂O₄), and magnesium oxalate (MgC₂O₄). In some embodiments, the oxalate is sodium oxalate at a concentration between about 0.5 mM and about 20 mM, including for example 0.75 mM, 1 mM, 1.5 mM, 2 mM, and 2.5 mM. In some embodiments, the oxalate is potassium oxalate at a concentration between about 0.5 mM and about 20 mM, including for example 0.75 mM, 1 mM, 1.5 mM, 2 mM, and 2.5 mM.

The acid in the eutectic composition may be any suitable acid known in the art. The acid is provided in the eutectic composition at a concentration suitable to modulate the reaction rate as desired and ensure that the reaction remains autocatalytic when in liquid form. The acid may be present at a concentration between about 1 mM and about 5.0 M, including but not limited to between about 1 mM and about 2.0 M, between about 1 mM and about 1.0 mM, between about 1 mM and about 500 mM, between about 1 mM and about 300 mM, between about 1 mM and about 100 mM, between about 1 mM and about 50 mM, between about 1 mM and about 25 mM, between about 1 mM and about 15 mM, between about 1 mM and about 10 mM, and between about 1 mM and about 5 mM. For example, the acid may be present at a concentration of about 1 mM, 2 mM, 3 mM, 4 mM, 5 mM, 6 mM, 7 mM, 8 mM, 9 mM, 10 mM, 15 mM, 20 mM, 30 mM, 40 mM, 50 mM, 60 mM, 70 mM, 80 mM, 90 mM, 100 mM, 125 mM, 150 mM, 175 mM, 200 mM, 225 mM, 250 mM, 275 mM, 300 mM, 350 mM, 400 mM, 450 mM, 500 mM, 750 mM, 1.0 M, 1.5 M, 2.0 M, 2.5 M, 3.0 M, 3.5 M, 4.0 M, 4.5 M, or 5.0 M. In some embodiments the acid concentration is between 1 mM and 500 mM, including for example 2 mM, 5 mM, 10 mM, 15 mM, 20 mM, 50 mM, 100 mM, and 200 mM. Suitable acids may be selected from any known inorganic acid including, but not limited to, sulfuric acid (H₂SO₄), hydrochloric acid (HCl), phosphoric acid (H₃PO₄), and perchloric acid (HClO₄). In some embodiments, the acid is perchloric acid.

The aqueous solvent as used herein refers to a suitable solvent comprising water. Suitable aqueous solvents may not interfere with the chemical reactions, absorbance measurement, or color detection as described herein. In some embodiments, the aqueous solvent is water.

The eutectic composition additionally includes an inorganic perchlorate salt. The inorganic perchlorate salt is present in the eutectic composition at a concentration suitable to maintain the eutectic nature of the composition as a whole. The inorganic perchlorate salt may be selected to tailor the predetermined freezing point to a desired storage or handling temperature or near the freezing point of the biospecimen. In some embodiments, the inorganic perchlorate salt is present at a concentration between about 10% and about 60% by weight of the eutectic composition. The concentration of the inorganic perchlorate salt can be, for example, between about 15% and about 60%, between about 20% and about 60%, between about 35% and about 60%, or between about 20% and about 55% by weight of the eutectic composition.

In some embodiments, the inorganic perchlorate salt comprises an alkali or alkaline-earth metal cation and a perchlorate counter anion. Suitable inorganic perchlorate salts include, but are not limited to, sodium perchlorate (NaClO₄), magnesium perchlorate (Mg(ClO₄)₂), and lithium perchlorate (LiClO₄). Specifically, lithium perchlorate salt is an indicator with a −18° C. melting point useful for temporary storage of fresh frozen plasma. As non-limiting examples, the eutectic composition can comprise between 20% and 30% by weight LiClO₄, between 50% and 54% by weight NaClO₄, between 42% and 46% by weight Mg(ClO₄)₂, or a mixture thereof.

Notably, not all cations in combination with the perchlorate anion can be used as the present inorganic perchlorate salt. For instance, some salts do not have eutectic points, while others with certain cations (e.g., Ca²⁺) could form an insoluble complex with the oxalate reactant and thus ruin the reaction system.

Perchlorate salts do not react with (e.g., cannot be oxidized by) permanganate and do not otherwise interfere with the visual indicator reaction. As a result, the presently described systems can be designed to run for much longer periods of time as compared to chloride-based inorganic salts (e.g., well over an hour at room temperature rather than just a few minutes at room temperature). Chloride can be oxidized by permanganate and therefore would interfere with the reaction to some extent if used. Other inorganic salts with eutectic freezing points that range from 0 to approximately −80° C. may also find utility in the present system. Notably, however, conventional organic antifreeze solutions such as ethylene or propylene glycol do not work for this purpose because they tend to react with the permanganate ion in a manner similar to that of oxalic acid.

The indicators described herein are suitable for applications in which the biospecimen has a desired storage and handling temperature below a threshold of 0° C. A “desired storage and handling temperature” is a temperature below which the biospecimen maintains its integrity. Below the desired storage and handling temperature, the reaction system described above will freeze and effectively halt indefinitely unless rewarmed. For the vast majority of biomolecules and biospecimens, the colder the temperature, the better the stabilization. However, there are some commercial applications, such as temporary storage of fresh frozen plasma, for which indicators that are active above (but halted below) 0° C. could be useful (e.g., lithium perchlorate).

In some embodiments, the predetermined freezing point is selected to be within the operating temperature of a freezer suitable for maintaining the biospecimen at a proper storage temperature or a temperature that maintains the biospecimen in a frozen state. Proper long-term preservation (e.g., biobanking) of many biospecimens, however, requires that they be stored at −80° C. or below (e.g., at the temperature of the vapor phase of liquid nitrogen, which is approximately −160° C.). Blood plasma and serum, for example, contain so much protein that these liquid specimens do not actually freeze until temperatures reach −30° C. or lower. As such, storage of blood plasma and serum at the common research laboratory freezer temperature of −20° C. is not acceptable because biochemical reactions within the samples can continue at this temperature, leading to sample expiration. Accordingly, a color-changing biospecimen integrity indicator that freezes at 0° C. would not be useful for comprehensively tracking the storage and handling conditions of an archived plasma or serum sample. An ideal tracker would be one that freezes near the freezing point of the specimen itself. If not available, a conservative tracker would be one that halted only at (or just above) the proper archival storage temperature. To enable this feature, the colorimetric indicators of the present disclosure are implemented in antifreeze solutions that permit the reactions to otherwise behave normally.

In some embodiments, the predetermined freezing point is selected to indicate failure of a freezer suitable for maintaining the biospecimen at a proper storage and handling temperature or a temperature that maintains the biospecimen in a frozen state.

Selection of the components allows for the tailoring of the predetermined freezing point to a desired storage and handling temperature. The freezing point of eutectic composition is specific for the combination of components, such as the inorganic perchlorate salt, and concentration of each of the components in the indicator system. The components of the indicator system may be selected based on known eutectic temperatures of inorganic perchlorate salts so that the freezing point is close to or specific to the biospecimen of interest or desired storage temperature. One exemplary embodiment includes 44% (w/w) magnesium perchlorate, which freezes eutectically at about −67° C. Another exemplary embodiment includes 52% (w/w) sodium perchlorate, which freezes eutectically at about −37° C. Yet another exemplary embodiment includes 25% (w/w) lithium perchlorate, which freezes eutectically at about −18° C. Other magnesium perchlorate, sodium perchlorate, and lithium perchlorate concentrations may result in a solution that either partially freezes or the salt partially precipitates out before the entire solution turns solid, causing kinetic control of the permanganate/oxalic acid reaction system to be lost.

In some embodiments, the freezing point of the eutectic composition is the same as or near the freezing point of the biospecimen of interest. As used herein, “freezing point near the freezing point of the biospecimen,” refers to a freezing point that is within 5° C. of the freezing point of the biospecimen. In some embodiments, the freezing point of the eutectic composition is within 2° C. of the freezing point of the biospecimen. In some embodiments, the freezing point of the eutectic composition is within 1° C. of the freezing point of the biospecimen.

In some embodiments, the predetermined freezing point may be below −5° C., −10° C., −15° C., −20° C., −25° C., −30° C., −35° C., −40° C., −45° C., −50° C., −55° C., −60° C., −65° C., −70° C., −75° C., −80° C., −85° C., or −90° C. In some embodiments, the predetermined freezing point is below −10° C. In some embodiments, the predetermined freezing point is below −30° C. In some embodiments, the predetermined freezing point is below −60° C. In some embodiments, the predetermined freezing point is −18° C., −37° C., or −67° C.

The predetermined freezing point may be selected to be within different temperature regimes. In some embodiments, the predetermined freezing point may be between 0° C. to −15° C., 0° C. to −18° C., 0° C. to −20° C., 0° C. to −25° C., 0° C. to −30° C., 0° C. to −35° C., 0° C. to −40° C., 0° C. to −45° C., 0° C. to −50° C., 0° C. to −55° C., 0° C. to −60° C., 0° C. to −65° C., 0° C. to −70° C., 0° C. to −75° C., 0° C. to −80° C., 0° C. to −85° C., −15° C. to −30° C., −15° C. to −35° C., −15° C. to −40° C., −15° C. to −45° C., −18° C. to −30° C., −18° C. to −35° C., −18° C. to −40° C., −18° C. to −45° C., −20° C. to −30° C., −20° C. to −35° C., −20° C. to −40° C., −20° C. to −45° C., −25° C. to −30° C., −25° C. to −35° C., −25° C. to −40° C., −25° C. to −45° C., −35° C. to −80° C., −40° C. to −80° C., −45° C. to −80° C., −50° C. to −80° C., −35° C. to −85° C., −40° C. to −85° C., −45° C. to −85° C., or −50° C. to −85° C.

In some embodiments, the indicator system comprises between 20% and 55% by weight of the inorganic perchlorate salt and wherein the predetermined freezing point is below −15.0° C. As a non-limiting example, the predetermined freezing point can be −18.0° C. and the eutectic composition can comprise between 20% and 30% by weight LiClO₄. As another non-limiting example, the predetermined freezing point can be −37.0° C. and the eutectic composition can comprise between 50% and 54% by weight NaClO₄. As another non-limiting example, the predetermined freezing point can be −67.0° C. and the eutectic composition can comprise between 42% and 46% by weight Mg(ClO₄)₂.

The reaction rate of the liquid eutectic composition can be modulated or tuned based on the compounds included in the compositions as well as the concentrations therein. In some embodiments, the concentration of the acid is increased to increase the reaction rate. In some embodiments, the concentration of the acid is reduced to reduce the reaction rate. In some embodiments, the initial concentration of Mn²⁺ in the system is increased to increase the reaction rate or reduced to reduce the reaction rate.

The color transition of the system is non-linear with time; specifically, it stays at the original bright pink color until shortly before it expires, and then, as the reaction approaches its end point, it undergoes a rapid transition from bright pink to clear. This is due to the autocatalytic nature of the reaction chemistry involved. In some cases (e.g., where magnesium perchlorate is used as the inorganic perchlorate salt), the system transitions from the original bright pink color to brown before turning clear.

Running simulations with different reaction starting conditions makes it possible to select the components of the indicator system with tailored lifetimes over different timescales. As used herein, the “lifetime” of the indicator system is the length of time necessary for the indicator system to go from the initially mixed eutectic composition to a state indicating thawing, improper storage, or improper handing at a particular temperature above the predetermined freezing point. In some embodiments, the indicator system has a lifetime less than 7 days, 6 days, 5 days, 4 days, 3 days, 2 days, 24 hrs, 18 hrs, 12 hrs, 6 hrs, 5 hrs, 4 hrs, 3 hrs, 2 hrs, 60 mins, 45 mins, 30 mins, 25 mins, 20 mins, 15 mins, 10 mins, 9, mins, 8 mins, 7 mins, 6 mins, 5 mins, 4 mins, 3 mins, 2 mins, or 1 min at a particular temperature above the predetermined freezing point.

In some embodiments, the chemical components are selected for the indicator system to have a lifetime of less than 120, 90, 60, 45, 30, 25, 20, 15, 10, 9, 8, 7, 6, 5, 4, 3, 2, or 1 min at 25° C. Indicator systems having lifetimes at 25° C. less than 120 mins may be appropriate for applications such as initial biospecimen collection and handling prior to storage. Indicator systems having lifetimes at 25° C. less than 1 min may be appropriate for applications such as long-term storage where storage above −30° C. or thawing of the biospecimen is improper.

In some embodiments, the chemical components are selected for the indicator system to have a lifetime of less than 24, 18, 12, 10, 9, 8, 7, 6, 5, 4, 3, 2, or 1 hr at 4° C. Indicator systems having lifetimes at 4° C. less than 24 hrs may be appropriate for applications such as initial biospecimen collection and handling prior to storage.

In some embodiments, the chemical components are selected for the indicator system to have a lifetime of less than 60, 45, 30, 25, 20, 15, 10, 9, 8, 7, 6, 5, 4, 3, 2, or 1 min at 0° C. Indicator systems having lifetimes at 0° C. less than 60 mins may be appropriate for applications such as long-term storage where brief storage above −30° C. or thawing of the biospecimen may be permissible.

In some embodiments, the chemical components are selected for the indicator system to have a lifetime of less than 7 days, 6 days, 5 days, 4 days, 3 days, 2 days, 24 hrs, 18 hrs, 12 hrs, 6 hrs, 5 hrs, 4 hrs, 3 hrs, or 2 hrs at −20° C. Indicator systems having lifetimes at −20° C. less than 4 hrs may be appropriate for applications such as long-term storage where storage above −30° C. or thawing of the biospecimen is improper. Indicator systems having lifetimes at −20° C. between 24 and 4 hrs may be appropriate for applications such as long-term storage where brief storage above −30° C. or thawing of the biospecimen may be permissible. Indicator systems having lifetimes at −20° C. between 7 and 1 days may be appropriate for applications such as collection or temporary storage of the biospecimen at sites lacking cold storage below −20° C.

Biospecimen collection and storage systems are also provided. The biospecimen collection and storage system may comprise any of the indicator systems described herein and a biospecimen storage vessel. As used herein, a “biospecimen storage vessel” is a vessel configured to hold a biospecimen. Suitably the biospecimen storage vessel is a well, vial, cup, bag, or other container suitable for storing a specimen for temporary or extended storage. As used herein, “temporary storage” refers to storage durations of hours, days, or up to about a week, and “extended storage” refers to storage durations of more than about a week, including storage durations of more than a month, more than a year, or unlimited duration storage.

In some cases, the present indicator can be stored within the cap or outer perimeter of the flex-activated vials, making it impossible to ignore improperly handled samples. For instance, once the bright pink color turns clear (as easily seen from the outside of the storage vial), this indicates that the specimen in the vial has been exposed to a total time-temperature span that is outside of the allowed storage/handling parameters. This will facilitate empirical biospecimen storage and handling tracking during initial biospecimen processing as well as over the entire life of an archived or biobanked specimen.

The indicator system should be initially configured to prevent reduction of the permanganate into Mn²⁺ but also configured to allow a user to prepare a mixture of the permanganate, the organic reducing agent, the acid, the aqueous solvent, and the perchlorate inorganic salt as an eutectic composition having a predetermined freezing point. This allows for the user to initiate the reduction reaction at the point where it would be desirable to begin monitoring the biospecimen.

In some embodiments, the indicator system will be associated outside of the biospecimen storage vessel and never physically touch the biospecimen that is to be stored in the biospecimen storage vessel. This allows for observation of the indicator system without disturbing a biospecimen within the biospecimen storage vessel.

In some embodiments, the indicator system may further comprise, or be configured as, a multi-chambered storage vessel that facilitates activation of the chemical reaction once the vessel is placed into use (i.e., once a biospecimen is placed inside it). The multi-chambered storage vessel may comprise a removable barrier defining at least a first chamber and a second chamber. As used herein, a “removable barrier” is one that is configured to be removed or lose structural integrity, thereby eliminating the distinction between the chambers. The chemical components (such as the permanganate and the organic reducing agent) may be distributed between the two or more chambers in any suitable manner that prevents reduction of permanganate to Mn²⁺. In some embodiments, the multi-chambered storage vessel comprises a removable barrier defining a first chamber having the permanganate therein and a second chamber having the organic reducing agent therein, wherein the removable barrier is configured to prevent the permanganate and the organic reducing agent from mixing. In some embodiments, the permanganate is housed in the first chamber and the organic reducing agent is housed in the second chamber. In particular embodiments, one chamber (e.g., the first chamber) houses a permanganate salt and the other chamber (e.g., the second chamber) houses a solution comprising the organic reducing agent, the acid, and the aqueous solvent. The inorganic perchlorate salt may be housed with the permanganate or with the solution. In some embodiments, the inorganic perchlorate salt is housed with the solution. In some embodiments, the first chamber has the permanganate therein and the second chamber has a solution comprising the organic reducing agent, the acid, the aqueous solvent, and the inorganic perchlorate salt therein. The indicator system may be initiated by bending, flexing, crushing, snapping, creasing, or breaking the removable barrier, thereby allowing chemical components in the different chambers to mix.

In another aspect, the present disclosure provides a biospecimen collection or storage system comprising a biospecimen storage vessel and the indicator system as described herein. As a non-limiting example, the indicator system can comprise a multi-chambered storage vessel comprising a removable barrier defining a first chamber having the permanganate therein and a second chamber having the organic reducing agent therein, wherein the removable barrier is configured to prevent the permanganate and the organic reducing agent from mixing.

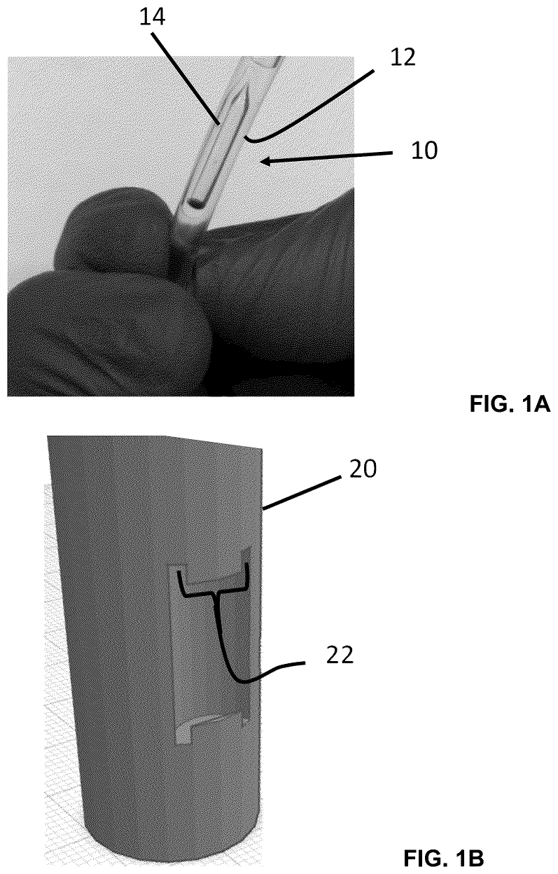

FIG. 1A shows an exemplary multi-chambered storage vessel 10. The multi-chambered storage vessel may comprise an outer chamber 12 and an inner chamber 14 defined by a removable barrier. In exemplary embodiments, the permanganate, such as a permanganate salt, may be housed within the inner chamber 14, and the organic reducing agent may be housed in the outer chamber 12. The outer chamber 12 may be surrounded by a flexible material that can be manipulated without losing structural integrity. Inner chamber 14, in contrast, may be surrounded by a rigid or brittle material that cannot withstand such manipulation. Such an indicator will allow mixing of the chemical components when the indicator is bent, flexed, creased, or snapped. Although the exemplary embodiment shown in FIG. 1A shows the inner chamber 14 within the outer chamber 12, the chambers may be configured in other arrangements, such as having the chambers side-by-side.

In some embodiments, the biospecimen storage vessel may be configured to be associated with the indicator system. An exemplary biospecimen collection vessel 20 is shown in FIG. 1B having a recess 22 that allows for the association of the biospecimen collection vessel with an indicator system, such as the indicator system illustrated in FIG. 1A. The recess 22 may be configured to reversibly or irreversibly associate with the indicator system on the outer surface of the biospecimen collection vessel 20. This may allow for observation of the indicator system without disturbing a biospecimen. In some embodiments, the present biospecimen collection or storage system comprises a recess configured to receive the indicator system and allows observation of the indicator system without disturbing the biospecimen.

In some embodiments, the biospecimen storage vessel and the indicator system are incorporated into a portion of a biospecimen storage vessel. For example, the indicator system may be incorporated into a cap, a wall, a parallel vertical or horizontal chamber, in a single well of a multiwell plate, or in multiple wells of a multiwell plate, each of which is also suitable for holding and storing the biospecimen.

In some embodiments, the indicator system may be incorporated into packaging that is intended to surround the biospecimen storage vessel. For example, the indicator system may be incorporated into a box or bag suitable for surrounding the biospecimen storage vessel.

The present systems provide a quality control (QC) tool for empirically tracking biospecimen exposures to thawed conditions or otherwise unacceptable time-temperature intervals. Specifically, it is a liquid-based color change system that tracks individual aliquot-level biospecimen exposures to time-temperature intervals that exceed a pre-defined limit and is designed to serve as an empirical monitor of total biospecimen exposure to thawed conditions. It may be implemented during initial processing or during long-term biospecimen storage in a biobank. When properly deployed, these indicators ensure the integrity of precious research biospecimens over the course of their entire lives (i.e., from the point of collection through long-term biobanking).

In certain embodiments, the indicating liquid is designed to be activated and stored within a transparent sub-compartment of a biospecimen storage and/or processing vessel. The indicating liquid comprises a bright pink colored solution that, once activated, stays bright pink for a pre-defined but customizable amount of time at a particular temperature, after which it turns colorless. Typical expiration time spans range from a few minutes to several hours. If the temperature warms, the solution turns colorless faster; if the temperature cools, the solution takes longer to turn color. If the solution is frozen, it stays pink indefinitely (i.e., the “clock” stops, but if re-thawed the “clock” restarts and the solution will eventually turn colorless).

Useful solution freezing points may include 0° C., −18° C., −37° C., or −67° C. Solutions with freezing points below 0° C. are useful for empirically tracking improper biospecimen storage, such as storage of blood plasma or serum at −20° C. (where it is not fully frozen) rather than at −80° C. In some embodiments, the inorganic perchlorate salt of the indicator system for the biospecimen collection or storage system comprises NaClO₄ or Mg(ClO₄)₂, and the predetermined freezing point is below −30° C.

In another aspect, provided herein a kit including the indicator system as described herein and a storage vessel that incorporates the indicator system and can be used to store the biospecimen. In some embodiments, the kit comprises separate solutions for each of the indicator system components.

In yet another aspect, provided herein is a method for monitoring storage or handling of a biospecimen comprising: storing a biospecimen in a biospecimen storage vessel; associating the indicator system as described herein with the biospecimen or the biospecimen storage vessel; mixing the permanganate, the organic reducing agent, the acid, the aqueous solvent, and the inorganic perchlorate salt, thereby forming the eutectic composition; observing the color of the eutectic composition or measuring absorbance at 525 nm; wherein a color change from pink to colorless or absorbance less than 0.1 indicates thawing, improper storage, or improper handling of the biospecimen.

In various embodiments, the present disclosure provides a method of monitoring the integrity of a biospecimen, including the steps of obtaining an indicator system as described herein with a predetermined freezing point near the freezing point of the biospecimen or a storage or handling temperature for the biospecimen, storing the biospecimen adjacent to the indicator system and handling the biospecimen and indicator system simultaneously, and observing the color of the indicator system. A change in color from pink to colorless indicates a loss of integrity of the biospecimen due to thawing, improper handling, or improper storage. Accordingly, a user may store a biospecimen in a biospecimen storage vessel and the indicator system may be associated with the biospecimen or the biospecimen storage vessel. When desirable to begin monitoring the storage or handling of the biospecimen, the permanganate, the organic reducing agent, the acid, the aqueous solvent, and the inorganic perchlorate salt may be mixed, thereby forming the eutectic composition. As a result of mixing, the indicator system will display a bright pink color and the permanganate reduction reaction will be initiated. When using an indicator system with a multi-chambered storage vessel, mixing the chemical components may be accomplished by removing the removable barrier separating the permanganate from the organic reducing agent. As a non-limiting example, the mixing step can comprise removing a removable barrier defining a first chamber of a multi-chambered storage vessel having a permanganate salt therein and a second chamber of the multi-chambered storage vessel having the organic reducing agent, the acid, the aqueous solvent, and the inorganic perchlorate salt therein.

In some embodiments, the inorganic perchlorate salt of the indicator system comprises NaClO₄ or Mg(ClO₄)₂ and the predetermined freezing point is below −30.0° C. In some embodiments, the color change may be observed with the naked eye. In some embodiments, the color change is observed by measuring absorbance of the indicator system at 525 nm. When the absorbance of the indicator system at 525 nm is less than 0.1, less than 0.05, or 0, the integrity of the biospecimen is lost due to thawing, improper handling, or improper storage. In some embodiments, the indicator system is in a well of a multiwell plate or in a cuvette to facilitate easy measuring of the absorbance.

Endogenous Mn²⁺ eradication: Mn²⁺ may be present as an autocatalytic contaminant in the reaction system that originate from as-purchased chemicals. For some targeted indicator solutions, this drives the reaction system faster than desired. Endogenous, contaminating Mn²⁺ species may be removed by the use of an inorganic cation exchange resin to bind multivalent metal cations. For example, pre-treating KMnO₄ is expected to minimize the Mn²⁺ contaminating species in the starting reaction system. Alternatively, prewashing all labware with ultrapure 2% nitric acid, passing ozone through the stock solutions and/or treating them with peroxodisulfate or sodium bismuthate to stoichiometrically oxidize all Mn²⁺ to MnO₄ may also be employed. Depletion of this contaminating species is important as this would allow for the reaction to be carried on for a longer duration and also minimize formation of MnO₂ that can result in a brown product.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein, the terms “approximately” or “about” in reference to a number are generally taken to include numbers that fall within a range of 5% in either direction (greater than or less than) the number unless otherwise stated or otherwise evident from the context (except where such number would exceed 100% of a possible value). Where ranges are stated, the endpoints are included within the range unless otherwise stated or otherwise evident from the context.

The present invention has been described in terms of one or more preferred embodiments, and it should be appreciated that many equivalents, alternatives, variations, and modifications, aside from those expressly stated, are possible and within the scope of the invention.

### EXAMPLES

Color change-based indicator liquids designed for multiple unique biospecimen handling/storage requirements are described herein. The internal chemical reaction “clock” that runs these indicators slows as samples are cooled and halted indefinitely when they are frozen—but restarts when samples are thawed, without limit to the number of freeze-thaw cycles. Subsets of these indicators do not freeze until −18° C., −37° C., or −67° C., facilitating the ability to track exposures to nominally very cold, but nevertheless improper, storage temperatures and in a manner that will be difficult to ignore by anyone handling the samples. Such indicators are useful for both biospecimen storage and handling tracking during initial biospecimen processing and for empirically tracking the integrity of an archived or biobanked specimen over the course of its entire life (i.e., within an archived biospecimen collection or biobank).

Specifically, the examples described herein involve a bright pink colored liquid solution that distinctly loses its color and changes to a clear liquid when exposed to time and temperature conditions that exceed a particular design threshold. Under “proper” specimen storage conditions, however they may be defined, a particular indicator solution composition may be defined in which it stays bright pink below the specified freezing point, but transitions to having no color at all when cumulatively exposed to time-temperature conditions that exceed allowable storage and handling requirements. The time it takes for the solution to transition to a clear color while it is above the pre-defined temperature limit (which is the designed freezing point of the indicator solution) depends on the exact solution composition—but is flexible depending on the purpose and requirements of the biospecimen for which it is meant to track.

### Example 1 Eutectic Composition Containing NaClO₄ as an Anti-Freeze Salt

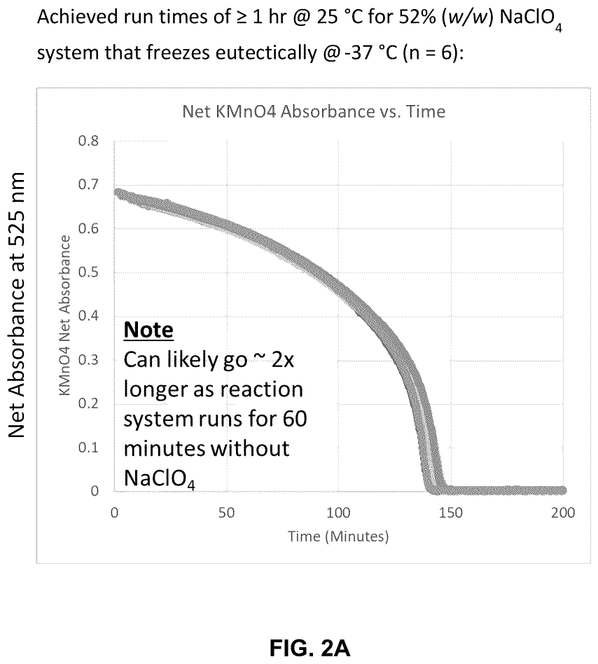

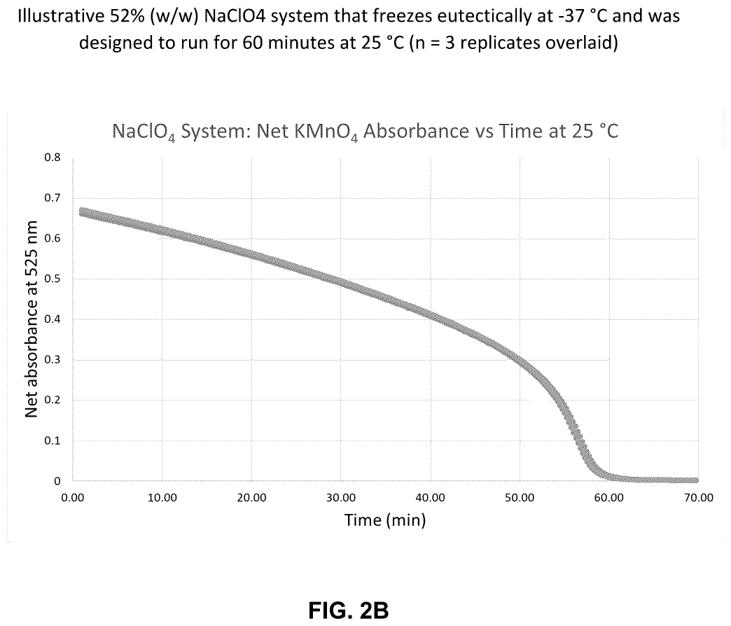

The eutectic composition of the indicator system has a freezing point of −37° C. and includes about 52% by weight NaClO₄. The final concentrations of potassium permanganate, disodium oxalate, and perchloric acid in the indicator system were 0.5 mM, 1.38 mM, and 10 mM, respectively. Reaction time courses for the eutectic composition containing NaClO₄ as an antifreeze salt was studied. An extended reaction times (e.g., an hour or longer) at room temperature was achieved. Permanganate reduction time courses (n=6) at 25° C. for a 52% (w/w) NaClO₄ system was monitored by measurement of absorbance at 525 nm (FIG. 2A). Additional tests (n=3) were conducted for a system designed to run for 60 minutes at 25° C. (FIG. 2B). Table 1 shows the run time reproducibility for the 52% (w/w) NaClO₄ system that freezes eutectically at −37° C. and was designed to run for 60 minutes at 25° C. (n=3 replicates per day×6 days).

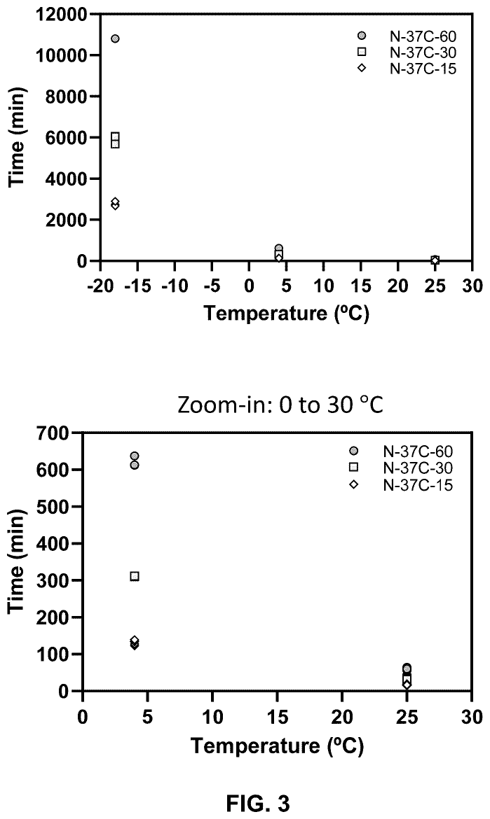

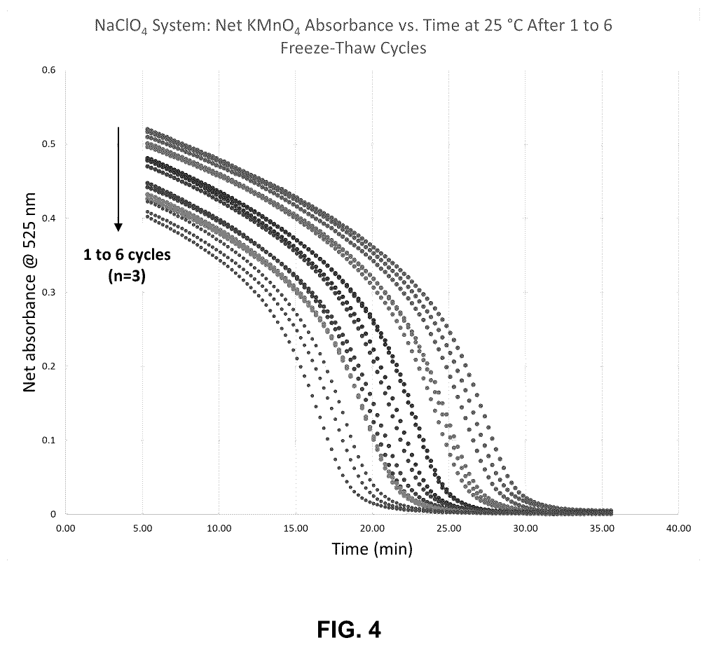

The run time vs. temperature profiles for a 52% (w/w) NaClO₄ systems that freeze eutectically at −37° C. were studied (FIG. 3). Further, the impact of multiple preliminary freeze-thaw cycles on final reaction run time for a 25% (w/w) NaClO₄ system that freezes eutectically at −37° C. was studied (FIG. 4). The system nominally runs for 30 minutes at 25° C. in the absence of any freeze-thaw cycles. Reactions were initiated then immediately flash-frozen in a dry ice/isopropanol bath. Then each preliminary freeze-thaw cycle consisted of removing the time-temperature indicator system from a −80° C. freezer, completely thawing it in a bath of room temperature water, then immediately returning it to the −80° C. freezer. Typically, the total time in the liquid state outside of the −80° C. freezer was 350-450 seconds.

### Example 2 Eutectic Composition Containing Mg(ClO₄)₂ as an Anti-Freeze Salt

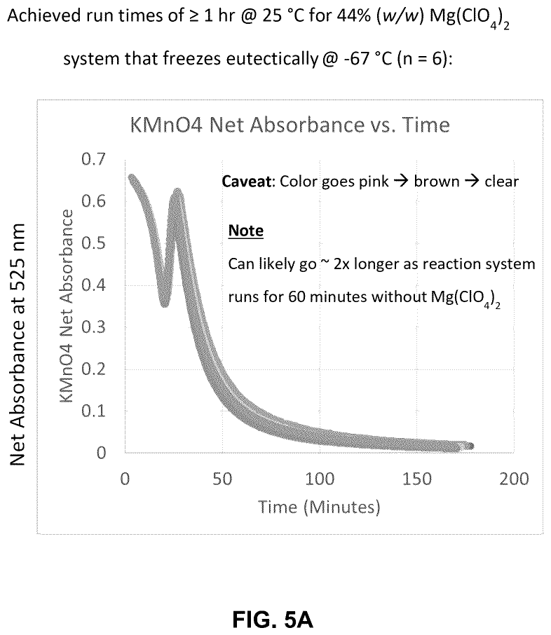

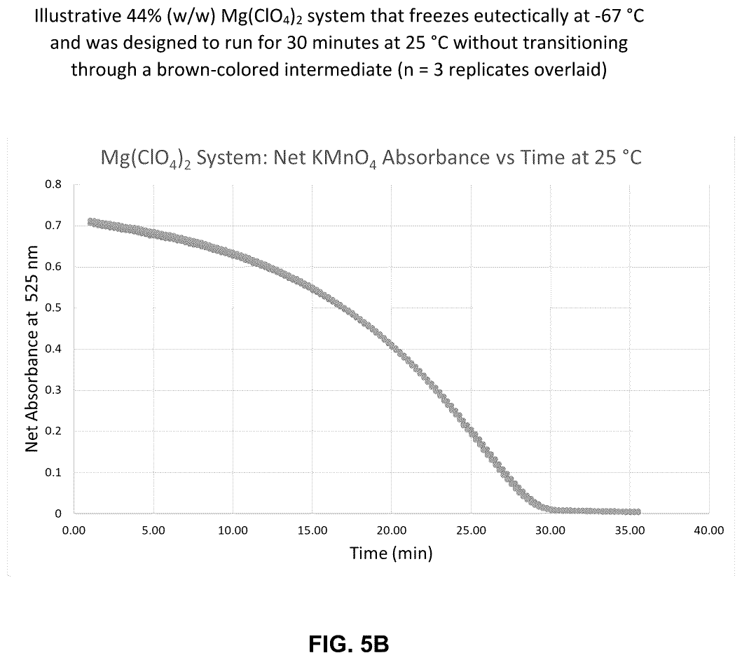

The eutectic composition of the indicator system has a freezing point of −67° C. and includes about 44% by weight Mg(ClO₄)₂. The final concentrations of potassium permanganate, disodium oxalate, and perchloric acid in the indicator system were 0.5 mM, 1.38 mM, and 10 mM, respectively. Reaction time courses for the eutectic composition containing Mg(ClO₄)₂ as an antifreeze salt was studied. An extended reaction times (e.g., an hour or longer) at room temperature was achieved. Permanganate reduction time courses (n=6) at 25° C. for a 44% (w/w) Mg(ClO₄)₂ system was monitored by measurement of absorbance at 525 nm (FIG. 5A). Additional tests (n=3) were conducted for a system designed to run for 30 minutes at 25° C. without transitioning through a brown-colored intermediate (FIG. 5B). Table 2 shows the run time reproducibility for the 44% (w/w) Mg(ClO₄)₂ system that freezes eutectically at −67° C. and was designed to run for 30 minutes at 25° C. without transitioning through a brown-colored intermediate (n=3 replicates per day×6 days).

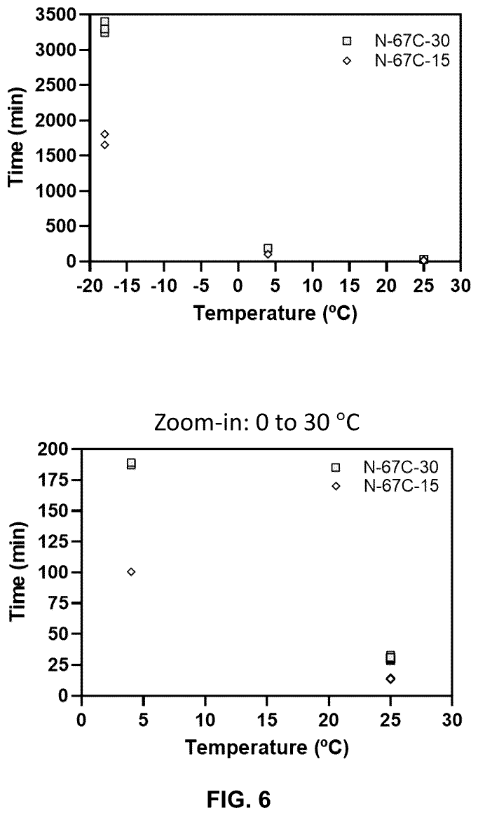

The run time vs. temperature profiles for a 44% (w/w) Mg(ClO₄)₂ systems that freeze eutectically at −67° C. without going through a brown-colored intermediate were studied (FIG. 6).

### Example 3 Eutectic Composition Containing LiClO₄ as an Anti-Freeze Salt

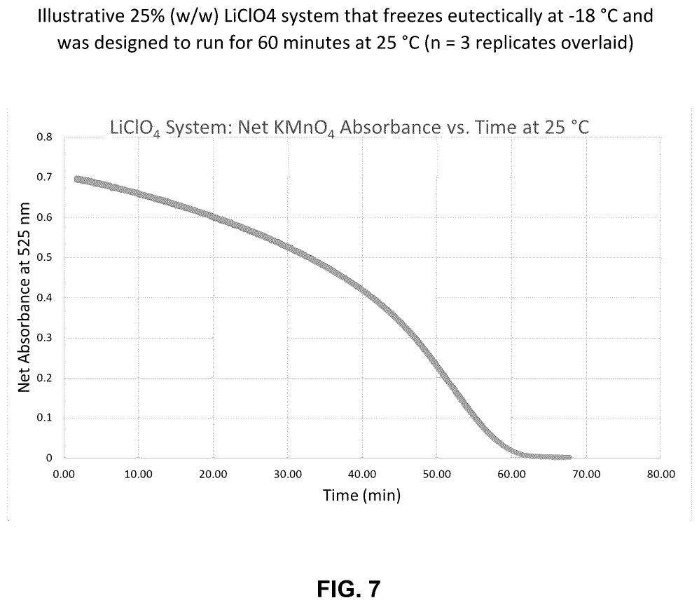

The eutectic composition of the indicator system has a freezing point of −18° C. and includes about 25% by weight LiClO₄. The final concentrations of potassium permanganate, disodium oxalate, and perchloric acid in the indicator system were 0.5 mM, 1.38 mM, and 5 mM, respectively. Reaction time courses for the eutectic composition containing LiClO₄ as an antifreeze salt was studied. Permanganate reduction time courses (n=3) at 25° C. for an illustrative 25% (w/w) LiClO₄ system that freezes eutectically at −18° C. was monitored by measurement of absorbance at 525 nm (FIG. 7), which was designed to run for 60 minutes at 25° C. Table 3 shows the run time reproducibility for the 25% (w/w) LiClO₄ system that freezes eutectically at −18° C. and was designed to run for 60 minutes at 25° C. (n=3 replicates per day×6 days).

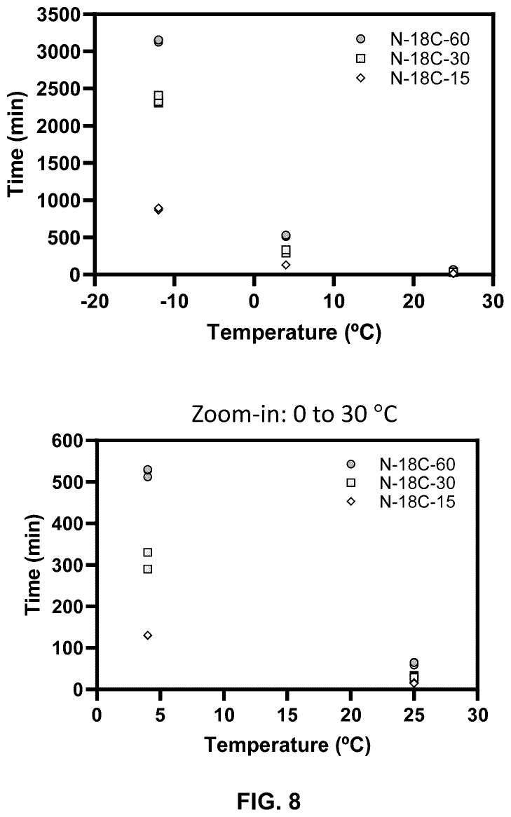

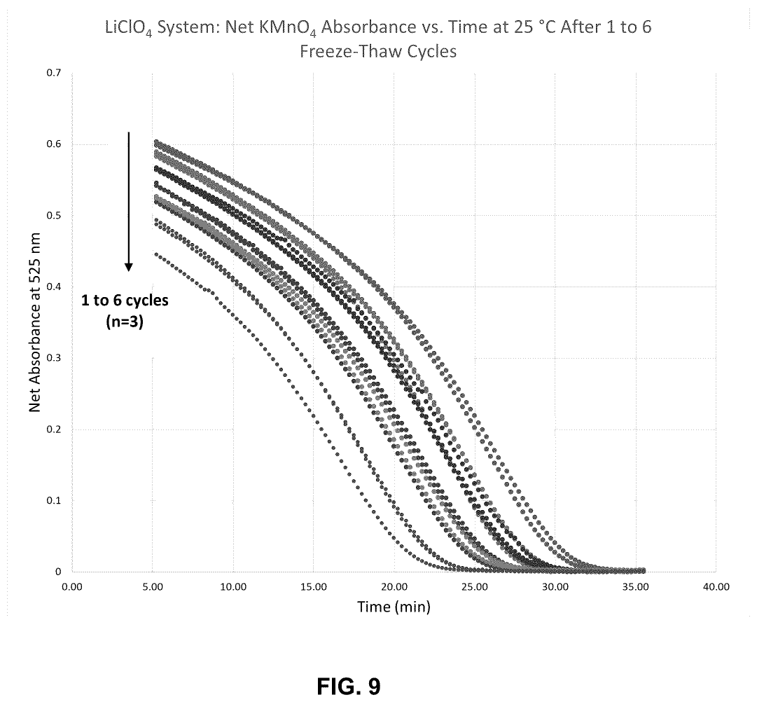

The run time vs. temperature profiles for a 25% (w/w) LiClO₄ systems that freeze eutectically at −18° C. were studied (FIG. 8). Further, the impact of multiple preliminary freeze-thaw cycles on final reaction run time for a 25% (w/w) LiClO₄ system that freezes eutectically at −18° C. was studied (FIG. 9). The system nominally runs for 30 minutes at 25° C. in the absence of any freeze-thaw cycles. Reactions were initiated then immediately flash-frozen in a dry ice/isopropanol bath. Then each preliminary freeze-thaw cycle consisted of removing the time-temperature indicator system from a −80° C. freezer, completely thawing it in a bath of room temperature water, then immediately returning it to the −80° C. freezer. Typically, the total time in the liquid state outside of the −80° C. freezer was 350-450 seconds.

TABLE 1
Run time reproducibility for 52% (w/w) NaClO₄ system

| | Day 1 | | | Day 2 | | | Day 3 | | |
|---|---|---|---|---|---|---|---|---|---|
| | Trial | Trial | Trial | Trial | Trial | Trial | Trial | Trial | Trial |
| | 1 | 2 | 3 | 1 | 2 | 3 | 1 | 2 | 3 |
| Run time | 59.59 | 57.59 | 58.84 | 64.13 | 64.13 | 63.63 | 59.36 | 59.11 | 59.36 |
| Deviation from 60 mins | 0.41 | 2.41 | 1.16 | −4.13 | −4.13 | −3.63 | 0.64 | 0.89 | 0.64 |
| % Deviation from 30 mins | 0.68 | 4.02 | 1.93 | 6.88 | 6.88 | 6.05 | 1.07 | 1.48 | 1.07 |
| Each day ending | 25 | | | 25 | | | 25 | | |
| temperature | | | | | | | | | |
| Each day start | 25.1 | | | 25.1 | | | 25.1 | | |
| temperature | | | | | | | | | |
| Each day Mean | 58.7 | | | 64.0 | | | 59.3 | | |
| Each day Stdev | 1.01 | | | 0.29 | | | 0.14 | | |
| Each day % CV | 1.722 | | | 0.451 | | | 0.243 | | |
| | Day 4 | | | Day 5 | | | Day 6 | | |
| | Trial | Trial | Trial | Trial | Trial | Trial | Trial | Trial | Trial |
| | 1 | 2 | 3 | 1 | 2 | 3 | 1 | 2 | 3 |
| Run time | 59.43 | 62.93 | 59.43 | 61.01 | 62.01 | 61.51 | 57.41 | 55.66 | 56.91 |
| Deviation from 60 mins | 0.57 | −2.93 | 0.57 | −1.01 | −2.01 | −1.51 | 2.59 | 4.34 | 3.09 |
| % Deviation from 30 mins | 0.95 | 4.88 | 0.95 | 1.68 | 3.35 | 2.52 | 4.32 | 7.23 | 5.15 |

| | | | |
|---|---|---|---|
| Each day ending | 25 | 25 | 25 |
| temperature | | | |
| Each day start | 25.1 | 25.1 | 25.1 |
| temperature | | | |
| Each day Mean | 60.6 | 61.5 | 56.7 |
| Each day Stdev | 2.02 | 0.50 | 0.90 |
| Each day % CV | 3.335 | 0.813 | 1.591 |

Total average of all runs: 60.11
Total SD of all runs: 2.52
Total % CV: 4.19
Average % deviation from 60 min: 3.39

TABLE 2
Run time reproducibility for 44% (w/w) Mg(ClO₄)₂ system

| | Day 1 | | | Day 2 | | | Day 3 | | |
|---|---|---|---|---|---|---|---|---|---|
| | Trial | Trial | Trial | Trial | Trial | Trial | Trial | Trial | Trial |
| | 1 | 2 | 3 | 1 | 2 | 3 | 1 | 2 | 3 |
| Run time | 31.01 | 31.01 | 31.01 | 31.29 | 31.04 | 30.79 | 30.03 | 30.53 | 30.03 |
| Deviation from 30 mins | −1.01 | −1.01 | −1.01 | −1.29 | −1.04 | −0.79 | −0.03 | −0.53 | −0.03 |
| % Deviation from 30 mins | 3.37 | 3.37 | 3.37 | 4.30 | 3.47 | 2.63 | 0.10 | 1.77 | 0.10 |
| Each day ending | 25 | | | 25 | | | 25 | | |
| temperature | | | | | | | | | |
| Each day start | 25.1 | | | 25.1 | | | 25.1 | | |
| temperature | | | | | | | | | |
| Each day Mean | 31.0 | | | 31.0 | | | 30.2 | | |
| Each day Stdev | 0.00 | | | 0.25 | | | 0.29 | | |
| Each day % CV | 0.000 | | | 0.805 | | | 0.956 | | |
| | Day 4 | | | Day 5 | | | Day 6 | | |
| | Trial | Trial | Trial | Trial | Trial | Trial | Trial | Trial | Trial |
| | 1 | 2 | 3 | 1 | 2 | 3 | 1 | 2 | 3 |
| Run time | 30.43 | 30.93 | 31.18 | 29.65 | 29.90 | 32.89 | 28.95 | 28.70 | 28.45 |
| Deviation from 30 mins | −0.43 | −0.93 | −1.18 | 0.35 | 0.10 | −2.89 | 1.05 | 1.30 | 1.55 |
| % Deviation from 30 mins | 1.43 | 3.10 | 3.93 | 1.17 | 0.33 | 9.63 | 3.50 | 4.33 | 5.17 |

| | | | |
|---|---|---|---|
| Each day ending | 25 | 25 | 25 |
| temperature | | | |
| Each day start | 25.1 | 25.1 | 25.1 |
| temperature | | | |
| Each day Mean | 30.8 | 30.8 | 28.7 |
| Each day Stdev | 0.38 | 1.80 | 0.25 |
| Each day % CV | 1.238 | 5.851 | 0.871 |

Total average of all runs: 30.43
Total SD of all runs: 1.07
Total % CV: 3.51
Average % deviation from 30 min: 3.06

TABLE 3
Run time reproducibility for 25% (w/w) LiClO₄ system

| | Day 1 | | | Day 2 | | | Day 3 | | |
|---|---|---|---|---|---|---|---|---|---|
| | Trial | Trial | Trial | Trial | Trial | Trial | Trial | Trial | Trial |
| | 1 | 2 | 3 | 1 | 2 | 3 | 1 | 2 | 3 |
| Run time | 64.90 | 65.10 | 65.40 | 59.18 | 63.93 | 58.68 | 62.85 | 64.35 | 61.10 |
| Deviation from 60 mins | −4.90 | −5.10 | −5.40 | 0.82 | −3.93 | 1.32 | −2.85 | −4.35 | −1.10 |
| % Deviation from 30 mins | 8.17 | 8.50 | 9.00 | 1.37 | 6.55 | 2.20 | 4.75 | 7.25 | 1.83 |
| Each day ending | 25 | | | 26 | | | 27 | | |
| temperature | | | | | | | | | |
| Each day start | 25.1 | | | 25.1 | | | 25.1 | | |
| temperature | | | | | | | | | |
| Each day Mean | 65.1 | | | 60.6 | | | 62.8 | | |
| Each day Stdev | 0.25 | | | 2.90 | | | 1.63 | | |
| Each day % CV | 0.386 | | | 4.782 | | | 2.592 | | |
| | Day 4 | | | Day 5 | | | Day 6 | | |
| | Trial | Trial | Trial | Trial | Trial | Trial | Trial | Trial | Trial |
| | 1 | 2 | 3 | 1 | 2 | 3 | 1 | 2 | 3 |
| Run time | 61.98 | 61.98 | 62.23 | 64.43 | 63.93 | 64.43 | 65.56 | 64.31 | 63.56 |
| Deviation from 60 mins | −1.98 | −1.98 | −2.23 | −4.43 | −3.93 | −4.43 | −5.56 | −4.31 | −3.56 |
| % Deviation from 30 mins | 3.30 | 3.30 | 3.72 | 7.38 | 6.55 | 7.38 | 9.27 | 7.18 | 5.93 |

| | | | |
|---|---|---|---|
| Each day ending | 28 | 29 | 30 |
| temperature | | | |
| Each day start | 25.1 | 25.1 | 25.1 |
| temperature | | | |
| Each day Mean | 62.1 | 64.3 | 64.5 |
| Each day Stdev | 0.14 | 0.29 | 1.01 |
| Each day % CV | 0.233 | 0.449 | 1.567 |

Total average of all runs: 63.22
Total SD of all runs: 2.01
Total % CV: 3.18
Average % deviation from 60 min: 5.76

For reasons of completeness, various aspects of the disclosure are set out in the following numbered clauses:

Clause 1. An indicator system comprising permanganate, an organic reducing agent, an acid, an aqueous solvent, and an inorganic perchlorate salt initially configured to prevent reduction of the permanganate to Mn²⁺,
wherein a mixture of the permanganate, the organic reducing agent, the acid, the aqueous solvent, and the inorganic perchlorate salt is an eutectic composition having a predetermined freezing point, and
wherein at temperature above the predetermined freezing point the organic reducing agent causes a reduction reaction of permanganate to Mn²⁺ and at temperature below the predetermined freezing point the reduction reaction is stopped.

Clause 2. The indicator system of clause 1, comprising between 0.5 mM and 5 mM permanganate, between 1 mM and 15 mM organic reducing agent, and between 1 mM and 300 mM acid.

Clause 3. The indicator system of any one of clauses 1-2, wherein the inorganic perchlorate salt comprises NaClO₄, Mg(ClO₄)₂, or LiClO₄.

Clause 4. The indicator system of any one of clauses 1-3, wherein the indicator system comprises between 15% and 60% by weight of the inorganic perchlorate salt.

Clause 5. The indicator system of any one of clauses 1-4, wherein the predetermined freezing point is below −10.0° C.

Clause 6. The indicator system of any one of clauses 1-5, wherein the indicator system comprises between 20% and 55% by weight of the inorganic perchlorate salt and wherein the predetermined freezing point is below −15.0° C.

Clause 7. The indicator system of any one of clauses 1-6, wherein the predetermined freezing point is −18.0° C. and the eutectic composition comprises between 20% and 30% by weight LiClO₄.

Clause 8. The indicator system of any one of clauses 1-6, wherein the predetermined freezing point is −37.0° C. and the eutectic composition comprises between 50% and 54% by weight NaClO₄.

Clause 9. The indicator system of any one of clauses 1-6, wherein the predetermined freezing point is −67.0° C. and the eutectic composition comprises between 42% and 46% by weight Mg(ClO₄)₂.

Clause 10. The indicator system of any one of clauses 1-9, wherein the permanganate is potassium permanganate.

Clause 11. The indicator system of any one of clauses 1-10, wherein the organic reducing agent is an oxalate.

Clause 12. The indicator system of any one of clauses 1-11, wherein the acid is perchloric acid.

Clause 13. The indicator system of any one of clauses 1-12, wherein the aqueous solvent is water.

Clause 14. The indicator system of any one of clauses 1-13, wherein the eutectic composition is pink in color upon mixing and wherein absorbance of the composition measured at 525 nm decreases over a predetermined period of time.

Clauses 15. The indicator system of any one of clauses 1-14, further comprising a multi-chambered storage vessel comprising a removable barrier defining a first chamber having the permanganate therein and a second chamber having the organic reducing agent therein, wherein the removable barrier is configured to prevent the permanganate and the organic reducing agent from mixing.

Clause 16. The indicator system of clause 15, wherein the first chamber has the permanganate therein and the second chamber has a solution comprising the organic reducing agent, the acid, the aqueous solvent, and the inorganic perchlorate salt therein.

Clause 17. A biospecimen collection or storage system comprising a biospecimen storage vessel and the indicator system according to clause 1.

Clause 18. The biospecimen collection or storage system of clause 17, wherein the inorganic perchlorate salt of the indicator system comprises NaClO₄ or Mg(ClO₄)₂, and the predetermined freezing point is below −30° C.

Clause 19. The biospecimen collection or storage system of any one of clauses 17-18, which comprises a recess configured to receive the indicator system and allows observation of the indicator system without disturbing the biospecimen.

Clause 20. The biospecimen collection or storage system of any one of clauses 17-19, wherein the indicator system further comprising a multi-chambered storage vessel comprising a removable barrier defining a first chamber having the permanganate therein and a second chamber having the organic reducing agent therein, wherein the removable barrier is configured to prevent the permanganate and the organic reducing agent from mixing.

Clause 21. A method for monitoring storage or handling of a biospecimen comprising
storing a biospecimen in a biospecimen storage vessel;
associating the indicator system according to clause 1 with the biospecimen or the biospecimen storage vessel;
mixing the permanganate, the organic reducing agent, the acid, the aqueous solvent, and the inorganic perchlorate salt, thereby forming the eutectic composition;
observing the color of the eutectic composition or measuring absorbance at 525 nm;
   wherein a color change from pink to colorless or absorbance less than 0.1 indicates thawing, improper storage, or improper handling of the biospecimen.

Clause 22. The method of clause 21, wherein the inorganic perchlorate salt of the indicator system comprises NaClO₄ or Mg(ClO₄)₂ and the predetermined freezing point is below −30.0° C.

Clause 23. The method of any one of clauses 21-22, wherein the mixing step comprises removing a removable barrier defining a first chamber of a multi-chambered storage vessel having a permanganate salt therein and a second chamber of the multi-chambered storage vessel having the organic reducing agent, the acid, the aqueous solvent, and the inorganic perchlorate salt therein.

We claim:

1. An indicator system comprising permanganate, an organic reducing agent, an acid, an aqueous solvent, and an inorganic perchlorate salt initially configured to prevent reduction of the permanganate to Mn²⁺,
wherein a mixture of the permanganate, the organic reducing agent, the acid, the aqueous solvent, and the inorganic perchlorate salt is an eutectic composition having a predetermined freezing point, and
wherein at temperature above the predetermined freezing point the organic reducing agent causes a reduction reaction of permanganate to Mn²⁺ and at temperature below the predetermined freezing point the reduction reaction is stopped.

2. The indicator system of claim 1, comprising between 0.5 mM and 5 mM permanganate, between 1 mM and 15 mM organic reducing agent, and between 1 mM and 300 mM acid.

3. The indicator system of claim 1, wherein the inorganic perchlorate salt comprises NaClO₄, Mg(ClO₄)₂, or LiClO₄.

4. The indicator system of claim 1, wherein the indicator system comprises between 15% and 60% by weight of the inorganic perchlorate salt.

5. The indicator system of claim 1, wherein the predetermined freezing point is below −10.0° C.

6. The indicator system of claim 1, wherein the indicator system comprises between 20% and 55% by weight of the inorganic perchlorate salt and wherein the predetermined freezing point is below −15.0° C.

7. The indicator system of claim 1, wherein the predetermined freezing point is −18.0° C. and the eutectic composition comprises between 20% and 30% by weight LiClO₄.

8. The indicator system of claim 1, wherein the predetermined freezing point is −37.0° C. and the eutectic composition comprises between 50% and 54% by weight NaClO₄.

9. The indicator system of claim 1, wherein the predetermined freezing point is −67.0° C. and the eutectic composition comprises between 42% and 46% by weight Mg(ClO₄)₂.

10. The indicator system of claim 1, wherein the permanganate is potassium permanganate; wherein the organic reducing agent is an oxalate; wherein the acid is perchloric acid; and/or wherein the aqueous solvent is water.

11-13. (canceled)

14. The indicator system of claim 1, wherein the eutectic composition is pink in color upon mixing and wherein absorbance of the composition measured at 525 nm decreases over a predetermined period of time.

15. The indicator system of claim 1, further comprising a multi-chambered storage vessel comprising a removable barrier defining a first chamber having the permanganate therein and a second chamber having the organic reducing agent therein, wherein the removable barrier is configured to prevent the permanganate and the organic reducing agent from mixing.

16. The indicator system of claim 15, wherein the first chamber has the permanganate therein and the second chamber has a solution comprising the organic reducing agent, the acid, the aqueous solvent, and the inorganic perchlorate salt therein.

17. A biospecimen collection or storage system comprising a biospecimen storage vessel and the indicator system according to claim 1.

18. The biospecimen collection or storage system of claim 17, wherein the inorganic perchlorate salt of the indicator system comprises NaClO₄ or Mg(ClO₄)₂, and the predetermined freezing point is below −30° C.

19. The biospecimen collection or storage system of claim 17, which comprises a recess configured to receive the indicator system and allows observation of the indicator system without disturbing the biospecimen.

20. The biospecimen collection or storage system of claim 17, wherein the indicator system further comprising a multi-chambered storage vessel comprising a removable barrier defining a first chamber having the permanganate therein and a second chamber having the organic reducing agent therein, wherein the removable barrier is configured to prevent the permanganate and the organic reducing agent from mixing.

21. A method for monitoring storage or handling of a biospecimen comprising:
storing a biospecimen in a biospecimen storage vessel;
associating the indicator system according to claim 1 with the biospecimen or the biospecimen storage vessel;
mixing the permanganate, the organic reducing agent, the acid, the aqueous solvent, and the inorganic perchlorate salt, thereby forming the eutectic composition;
observing the color of the eutectic composition or measuring absorbance at 525 nm;
wherein a color change from pink to colorless or absorbance less than 0.1 indicates thawing, improper storage, or improper handling of the biospecimen.

22. The method of claim 21, wherein the inorganic perchlorate salt of the indicator system comprises NaClO₄ or Mg(ClO₄)₂ and the predetermined freezing point is below −30.0° C.

23. The method of claim 21, wherein the mixing step comprises removing a removable barrier defining a first chamber of a multi-chambered storage vessel having a permanganate salt therein and a second chamber of the multi-chambered storage vessel having the organic reducing agent, the acid, the aqueous solvent, and the inorganic perchlorate salt therein.
